(19) United States
(12) Patent Application Publication
(10) Pub. No.: US 2026/0336816 A1
(43) Pub. Date: Oct. 29, 2026

(54) DEVICE FOR COUPLING A PROPULSION SYSTEM TO AN ENGINE PYLON OF AN AIRCRAFT, AND CORRESPONDING AIRCRAFT

(71) Applicant: Airbus Operations SAS, TOULOUSE (FR)

(72) Inventors: Lionel CZAPLA, TOULOUSE (FR); Kotaro FUKASAKU, TOULOUSE (FR); Rémi AMARGIER, TOULOUSE (FR)

(21) Appl. No.: 19/659,332

(22) Filed: Apr. 27, 2026

(30) Foreign Application Priority Data
Apr. 29, 2025 (FR) FR2504550

(51) Int. Cl. B64D 27/40

(52) U.S. Cl. CPC B64D 27/402

(57) ABSTRACT

A device for coupling a propulsion system to an engine pylon of an aircraft. The device having a support with a base suitable for being fastened to the propulsion system, and a first wall extending substantially perpendicularly to the base. The first wall of the support interacts with a sleeve, a pair of flanges, and a fastener to connect the propulsion system to the engine pylon. A deformable spacer is disposed onto the sleeve between one of the flanges and the engine pylon and is configured to deform in the event of failure so as to absorb the excessive load generated by the failure. Also an aircraft with such a device.

### CROSS-REFERENCES TO RELATED APPLICATIONS

This application claims the benefit of French Patent Application Number FR 2504550, filed on Apr. 29, 2025, the entire disclosure of which is incorporated herein by way of reference.

### FIELD OF THE INVENTION

The present invention relates to a device for coupling a propulsion system to the wing of an aircraft. More specifically, the invention relates to a device for coupling a propulsion system to the engine pylon of the aircraft, and to an aircraft comprising a propulsion system and at least one such device for coupling the propulsion system to the engine pylon.

### BACKGROUND OF THE INVENTION

Usually, for an aircraft, a propulsion unit comprises for example a turbojet engine that is fastened to a wing of the aircraft using an engine pylon. The engine pylon generally consists of a structure comprising a plurality of tubes fastened to ribs.

The turbojet engine is fastened to the ribs of the engine pylon by means of engine mounts that conventionally comprise a plurality of front engine mounts at the front, and a plurality of rear engine mounts at the rear.

FIG. 2 illustrates an example of a prior art mount 9 for coupling a turbojet engine T to the engine pylon M of an aircraft. The mount 9 comprises a support 90 in the shape of an inverted T, comprising a base 900 from which a wall 902 extends substantially perpendicularly. The base 900 has a generally quadrilateral shape and is intended to be in contact with the turbojet engine T and fastened to the turbojet engine T, for example using threaded fasteners.

The wall 902 comprises a bore in which a sleeve (not shown) is housed, which itself has a bore through which is threaded a fastening pin 91 that is fastened to the engine pylon M, for example by screwing. The mount 9 further comprises shock absorbing pads 92 implemented on either side of the wall 902 of the support 90 and held by a set of flanges 93 in order to partially absorb the forces generated by the turbojet engine. A mount 9 implementing pads 92 is also referred to as a flexible mount. A spacer 94 can also be implemented, around part of the sleeve, between the mount 9 and the engine pylon M.

Although the current installations are satisfactory in terms of fastening the turbojet engine to the engine pylon, the implementation of these installations is suboptimal when it comes to managing a failure scenario, such as fan blade tear-out. Specifically, such a failure leads to high loading of the structure, particularly of the engine pylon and of the wing of the aircraft.

### SUMMARY OF THE INVENTION

One object of the present invention is to propose a device for coupling a propulsion system to the engine pylon rigidly connected to a wing of an aircraft, this device providing a solution for fastening a propulsion system that offers greater security in the event of failure.

To this end, a device is proposed for coupling a propulsion system to an engine pylon of an aircraft, said device comprising:
a support substantially in the shape of an inverted T, said support comprising a base suitable for being fastened to said propulsion system and a first wall extending substantially perpendicularly to said base, said first wall comprising a first bore extending along a longitudinal axis;
a substantially tubular sleeve comprising a first portion threaded into said bore, said first sleeve comprising a second portion a first end of which extends in the continuation of said first portion towards said engine pylon, and a second end of which is suitable for interacting with said engine pylon, said sleeve comprising a first central bore coaxial with said longitudinal axis;
fastening means comprising a nut suitable for being rigidly connected to said engine pylon and a fastening screw comprising a fastening head from which extends a threaded shank, said threaded shank being threaded through said central bore and screwed into said nut;
a first front flange and a first rear flange, said first flanges being arranged respectively on either side of said first wall, said first front flange comprising a second bore extending coaxially with said longitudinal axis, said first rear flange comprising a third bore extending coaxially with said longitudinal axis;
a first spacer suitable for being arranged between said first rear flange and said engine pylon, said first spacer comprising a second central bore coaxial with said longitudinal axis so that said first spacer is threaded onto said second portion of said sleeve.

Said first portion of said sleeve is threaded through said bores of said first flanges and said fastening head bears against said first front flange.

According to the invention, said first spacer comprises at least one weakened portion configured to allow said first spacer to deform when a force greater than a predetermined force is applied to it.

In this way, should the propulsion system or the mount suffer a partial or complete failure, the deformable spacer is able to absorb the great load brought about by the failure, notably so as to prevent this great load from being transmitted to the structure of the aircraft (and particularly to the wing of the aircraft). The result of this is that the structure of the aircraft is better protected.

According to one particular aspect of the invention, the device further comprises a second spacer suitable for being arranged between said first front flange and said fastening head, said second spacer comprising a third central bore coaxial with said longitudinal axis so that said second spacer is threaded onto said threaded shank of said fastening screw and said fastening head bears against said second spacer. In particular, and in the same way as the first spacer, said second spacer comprises at least one weakened portion configured to allow said second spacer to deform when a force greater than said predetermined force is applied to it.

According to another particular aspect of the invention, said predetermined force is 2% greater than a maximum force that can be applied to said first and/or second spacer in normal operation.

According to yet another particular aspect of the invention, each weakened portion takes the form of a groove that extends generally parallel to said longitudinal axis.

According to another particular aspect of the invention, each weakened portion takes the form of a groove that extends generally transversely with respect to said longitudinal axis.

According to one particular aspect of the invention, each spacer is made from a ductile material.

According to one particular aspect of the invention, said device also comprises:
a second front flange and a second rear flange, said second front flange and rear flange being arranged respectively on either side of said first wall, and in direct contact with said first wall, said second front flange comprising a fourth bore extending coaxially with said longitudinal axis, said second rear flange comprising a fifth bore extending coaxially with said longitudinal axis; and
a front pad and a rear pad that are arranged respectively against said second front flange and against said second rear flange, said front pad comprising a sixth bore extending coaxially with said longitudinal axis, said rear pad comprising a seventh bore extending coaxially with said longitudinal axis.

Said first portion of said sleeve is threaded through said bores of said second flanges and through said sixth bore and seventh bore of said pads. Said device further comprises a positioning assembly for positioning said second front flange and said second rear flange with respect to said first wall.

According to another particular aspect of the invention, the second front flange comprises two first positioning slots arranged at opposite ends of said second front flange, said second rear flange comprises two second positioning slots arranged at opposite ends of said second rear flange, and said first wall comprises two positioning holes arranged at opposite ends of said first wall. Said first positioning slots, said second positioning slots and said positioning holes extend respectively coaxially with and generally parallel to said longitudinal axis. Said positioning assembly also comprises two positioning pins which are threaded respectively through a first positioning slot, through a second positioning slot and through a positioning hole.

The invention also proposes an aircraft comprising a propulsion system, an engine pylon and at least one device as described above, said propulsion system being coupled to the engine pylon by said at least one device, wherein said support is fastened to said propulsion system, and said first and second nuts are rigidly connected to said engine pylon.

### BRIEF DESCRIPTION OF THE DRAWINGS

The aforementioned features of the invention, along with others, will become more apparent on reading the following description of an embodiment and its variants, said description being given with reference to the appended drawings, in which:

FIG. 1 is a side view of an aircraft according to the invention;

FIG. 2 is a perspective view of a mount according to a prior art solution;

FIG. 3 is a perspective view of a coupling device according to one exemplary embodiment of the invention;

FIG. 4 is a cross-sectional side view of the device of FIG. 3;

FIG. 5 is a cross-sectional side view of the device of FIG. 3 on the occasion of a failure;

FIG. 6 is a cross-sectional side view of a variant of the device of FIG. 3;

FIG. 7a is a side view of a first example of a spacer according to the invention;

FIG. 7b is a side view of a second example of a spacer according to the invention;

FIG. 7c is a side view of a third example of a spacer according to the invention;

FIG. 7d is a side view of a fourth example of a spacer according to the invention; and

FIG. 7e is a side view of a fifth example of a spacer according to the invention.

### DETAILED DESCRIPTION OF THE PREFERRED EMBODIMENTS

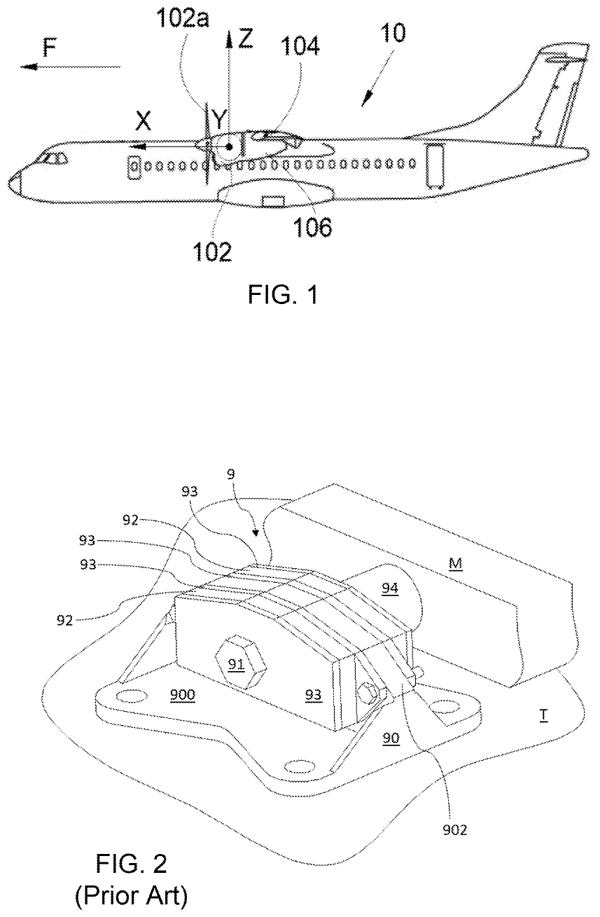

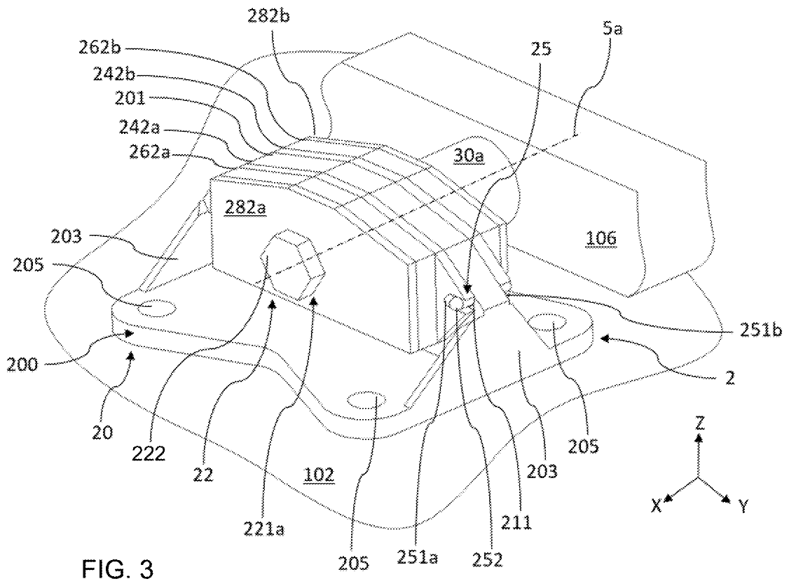

FIG. 1 shows an aircraft 10 that comprises a propulsion system 102, for example a turbojet engine or turboprop engine. The propulsion system 102 is connected to a wing 104 of the aircraft 10 by means of an engine pylon 106.

In the following description, terms relating to a position are given with reference to an aircraft in the normal flight position, that is, as shown in FIG. 1, and the positions “front” and “rear” are given relative to the front and rear of the propulsion system and relative to the direction of travel F of the aircraft 10 when the propulsion system is operating.

In the following description, and by convention, the X direction is the longitudinal direction of the propulsion system, which is horizontal when the aircraft is on the ground, the Y direction is the transverse direction, which is horizontal when the aircraft is on the ground, and the Z direction is the vertical direction, which is vertical when the aircraft is on the ground, these three directions X, Y and Z being mutually orthogonal.

The engine pylon 106 and the propulsion system 102 have a vertical mid-plane XZ and the propulsion system 102 is in this case a turboprop engine with a propeller 102a, but it could be a turbofan engine with a nacelle.

The principle of the invention is to provide a device 2 for coupling a propulsion system 102 to the engine pylon 106 of an aircraft 10 that employs a deformable element capable of absorbing a great load generated if the propulsion system coupling device 2 should suffer partial or total failure, notably so as to prevent this great load from being transmitted to the structure of the aircraft (and particularly to the wing of the aircraft). Furthermore, should a mounting device 2 become defective, the other devices 2 are liable to experience loads greater than their normal loads. Their respective deformable elements are then able to absorb this excess load.

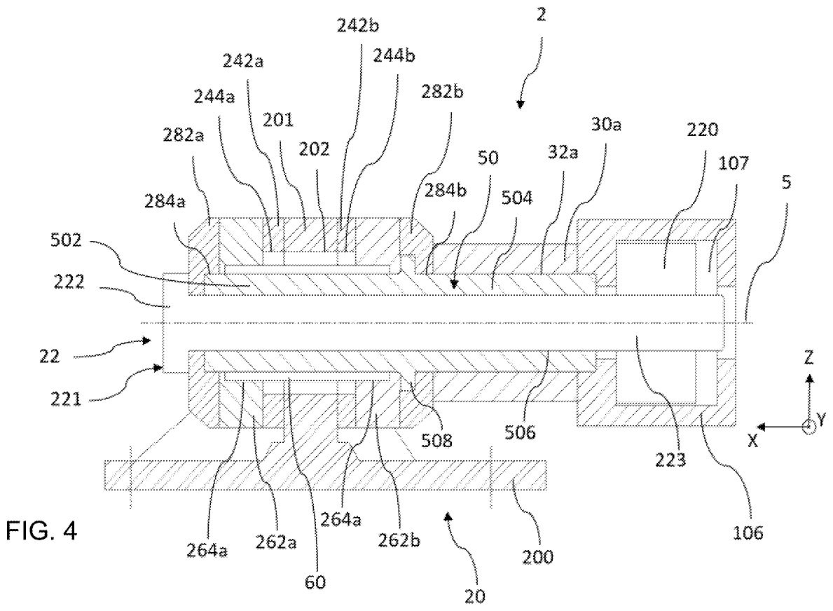

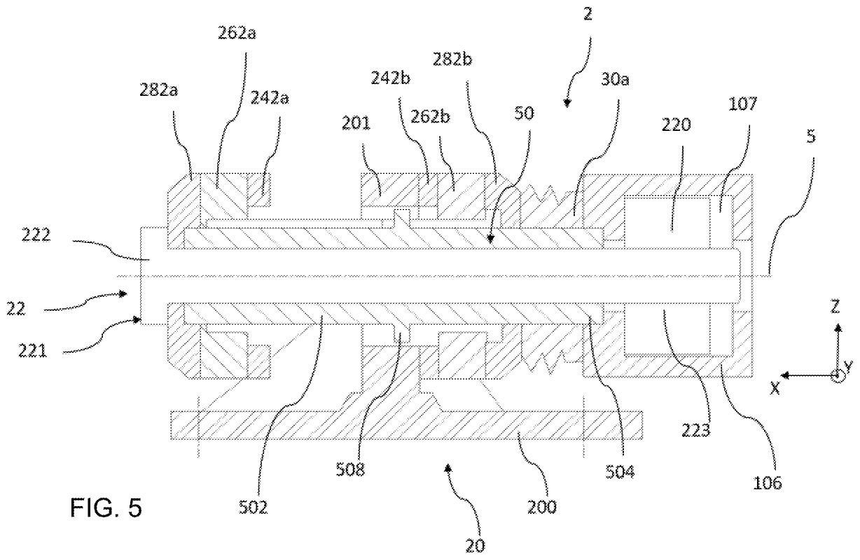

FIGS. 3 and 4 show a device 2 for coupling a propulsion system 102 to the engine pylon 106 of the aircraft 10 according to a main embodiment of the invention. Here, the device 2 is illustrated horizontally so that the elements can be described in relation to the orthonormal coordinate system X, Y, Z described above. It will clearly be understood that the device 2 can be arranged and oriented differently in order to adapt to the propulsion system 102 and engine pylon 106 to which the device is fastened. FIG. 4 illustrates a side view in cross section on a plane of section (not illustrated) that extends parallel to the vertical plane XZ and passes through the axis of the fastening screw described in greater detail later on in this description.

In this example, the device 2 comprises a support 20 substantially (+/−10%) in the shape of an inverted T. This support 20 comprises a substantially flat base 200, which in this illustration extends in a plane parallel to the horizontal plane XY. The base 200 is suitable for being fastened to the propulsion system 102 by fastening means such as threaded elements.

To this end, the base 200 has, in this example, holes 205 made at least in each corner of the base 200. The holes 205 are each suitable for receiving a fastening screw to allow a screw fastening. Other techniques for fastening the support to the propulsion system can be envisaged, such as riveting or welding in particular.

The support 20 comprises a first wall 201 that extends perpendicularly to the base 200, that is, in a plane parallel to the vertical plane YZ. The first wall 201 comprises a first bore 202a which extends along a longitudinal axis 5. The support 20 can also comprise, as in this example, lateral reinforcing walls 203 extending between the base 200 and the first wall 201, at the lateral edges of the support 20, so as to absorb the mechanical forces. In this example, the lateral walls 203 are triangular.

The device 2 also comprises a sleeve 50 comprising a first portion 502 at least part of which is received in the first bore 202 of the support 20. The sleeve 50 comprises a second portion 504 of which a first end extends from and in the continuation of the first portion 502 towards the engine pylon 106. As illustrated in FIG. 4, the free end of the second portion 504 is suitable for interacting with the engine pylon 106. More specifically, the free end of the second portion 504 is fitted into a recess 107 made in the engine pylon 106.

In this example, the first portion 502 and second portion 504 are separated by a shoulder 508 making it possible to optimize the positioning of the sleeve 50.

The sleeve 50 further comprises a first central bore 506 extending coaxially with the longitudinal axis 5. The first central bore 506 is suitable for receiving a fastening screw 221, described below.

The device 2 comprises fastening means 22 that make it possible to fasten the device 2 to the engine pylon 106. To this end, the fastening means 22 comprise a nut 220 rigidly connected to the engine pylon 106 and a fastening screw 221. In this example, the nut 220 rigidly connected to the engine pylon 106 is captive, but any other type of nut that can be rigidly connected to the engine pylon 106 can be implemented. An assembly clearance is preferably provided between the free end of the second portion 504 of the sleeve 50 and the nut 220, so as to allow the deformation of the pads described hereinafter on the tightening of the fastening screw 221, and so as to allow compression of the spacer 30 (as described hereinafter) between the first rear flange 282b and the engine pylon 106.

The first fastening screw 221 comprises a fastening head 222 arranged at the opposite end from the engine pylon 106 and that bears against a first front flange 282a (described below). The first fastening screw 221 comprises a threaded shank 223 which extends from the fastening head 222 along the longitudinal axis 5.

The threaded shank 223 is threaded or passed into the first central bore 506 of the first sleeve 50 and has a length greater than the length of the sleeve 50 so that it can be screwed into the nut 220 rigidly connected to the engine pylon 106. The sleeve 50 thus makes it possible to transfer the shear forces generated by the propulsion system 102 to the engine pylon 106, in particular via the fastening means 22.

The device 2 further comprises a pair of first flanges comprising a first front flange 282a and a first rear flange 282b. The first front flange 282a and rear flange 282b are respectively arranged on either side of the first wall 201 of the support 20.

The first front flange 282a comprises a second bore 284a which extends coaxially with the longitudinal axis. The first rear flange 282b comprises a third bore 284b which also extends coaxially with the longitudinal axis 5. The dimensions of the bores 284a, 284b are configured so that they can receive the first portion 502 of the sleeve 50. In this example, no radial assembly clearance is provided between the bores 284a, 284b and the first portion 502 of the sleeve 50 in order to allow conjoint radial movement between the sleeve 50 and the first front flange 282a and rear flange 282b. The sleeve 50 is able to drive the first front flange 282a and rear flange 282b, which in turn cause the deformation of the pads 262a, 262b.

The device 2 also comprises a spacer 30 suitable for being arranged between the first rear flange 282b and the engine pylon 106, and for bearing against the first rear flange 282b and the engine pylon 106 when the device 2 is assembled. When the fastening screw 221 is tightened, the spacer 30 is therefore compressed between the first rear flange 282b and the engine pylon 106.

The spacer 30 comprises a second central bore 32 extending coaxially with the longitudinal axis 5. The dimensions of the second central bore 32 are configured so that they can receive the second portion 504 of the sleeve 50. More specifically, the spacer 30 is threaded and thus disposed onto the second portion 504a of the sleeve 50 and therefore extends around the second portion 504 of said sleeve 50.

The first portion 502 of the sleeve 50 therefore passes through the second bore 284a and third bore 284b of the first flanges 282a, 282b and the fastening head 222 of the fastening screw 221 bears against the first front flange 282a. The threaded shank 223 of the fastening screw 221 passes through the first central bore 506 of the sleeve 50 to be screwed into the nut 220 rigidly connected to the engine pylon 106.

According to the invention, the spacer 30 is deformable. That makes it possible to absorb the very great loads that may be brought about in the event of failure of the propulsion system. In particular, the spacer 30 can deform and for example be crushed, or even break, in the event of excessively great loads, so as to protect the structure of the aircraft. This crushing of the spacer 30 makes it possible for any loads generated on the occasion of a failure not to be transmitted to the structure of the aircraft 10, and notably to the wing 14 of the aircraft 10. For example, blade tear-out from the propeller and/or fan of the propulsion system 102 may generate very great loads.

As a preference, the spacer 30 is configured to deform when a predetermined force or load is applied to it. This predetermined force is for example 2% or even 5% greater than the maximum load applied to it in normal operation.

Thus, the spacer 30 deforms only if the load applied to it is sufficient, the reason for this being to avoid any undesired crushing or breakage. Specifically, the spacer 30 is constantly subjected to load due to the operation of the propulsion system 102. It must deform only when a failure of the device 2 occurs.

In addition, the spacer 30 is configured to deform before the other elements of the device 2 experience any failure/damage, so as to protect such elements.

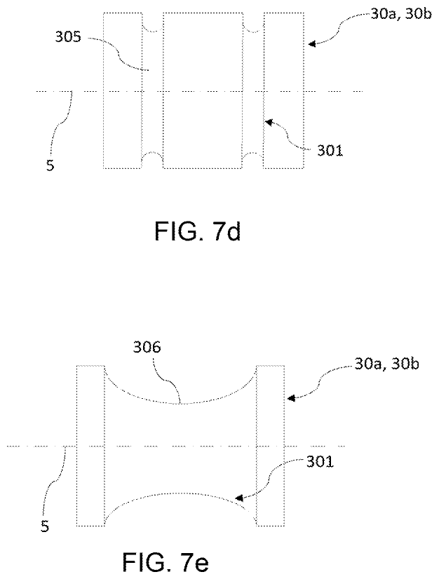

In order to achieve that, the spacer 30 has a weakened portion 301 (illustrated in FIGS. 7a to 7e) configured to allow the spacer to deform when a force greater than said predetermined force is reached.

In the examples depicted, the spacer 30a, 30b has a substantially tubular shape. However, it is possible to envisage for the spacer 30a, 30b to have a conical shape or any other shape that allows it to deform easily.

For example, the weakened portion takes the form of a groove 302, 303, 304 (that may or may not pass all the way through) that extends generally parallel to the longitudinal axis 5 (as illustrated in FIGS. 7a to 7c).

In particular, FIG. 7a illustrates a spacer 30a, 30b that has a groove 302 of rectilinear shape extending along the entire length of the spacer 30a, 30b. This groove 302 extends generally parallel to the longitudinal axis 5. In this example, the groove 302 extends along the entire length of the spacer 30a, 30b and therefore does not pass all the way through. It is also possible to envisage for the groove 302 not to extend along the entire length of the spacer 30a, 30b. In that case, the groove 302 could then not pass all the way through or indeed could pass all the way through (which is to say extend over the entire thickness of the spacer 30a, 30b).

FIG. 7b illustrates a spacer 30a, 30b which comprises a groove 303 of oblong overall shape and which extends generally parallel to the longitudinal axis 5. In this example, the groove 303 passes all the way through. However, it will be appreciated that it could also not pass all the way through.

FIG. 7c illustrates a spacer 30a, 30b which comprises a groove 304 of oval overall shape and which extends generally (+/−10%) parallel to the longitudinal axis 5. In this example, the groove 304 passes all the way through. However, it will be appreciated that it could also not pass all the way through.

In a variant, the weakened portion 301 takes the form of a groove 305, 306 (that may or may not pass all the way through) that extends generally transversely with respect to the longitudinal axis 5 (as illustrated in FIGS. 7d and 7e).

In particular, FIG. 7d illustrates a spacer 30a, 30b which comprises two grooves 305 that extend parallel to one another and transversely with respect to the longitudinal axis 5. These grooves 305 here also extend around the entire periphery of the spacer 30a, 30b. The grooves 305 are generally rectilinear and have a generally circular cross section.

FIG. 7e illustrates a spacer 30a, 30b which comprises a single groove 306 which extends generally transversely with respect to the longitudinal axis 5. The groove 306 is generally centered with respect to the length of the spacer 30a, 30b and has a cross section that curves in towards the center of the spacer 30a, 30b.

These particular shapes for the grooves 302-306 make it possible to ensure optimal deformation of the spacer 30a, 30b at the desired load. However, it will be understood that other shapes of groove (not illustrated here) can be envisaged without departing from the general principle of the invention.

In addition, and in order to obtain the deformation at the desired load, the material from which the spacer 30 is manufactured and the dimensions (particularly the thickness) can be selected accordingly. As a preference, the material is ductile so that it does not break as soon as the predetermined force is reached. The spacer can therefore first deform. It may for example be made of aluminum, titanium or even steel.

The device 2 further comprises a pair of second flanges comprising a second front flange 242a and a second rear flange 242b. The second front flange 242a and rear flange 242b are respectively arranged on either side of the first wall 201 of the support 20 and in direct contact with the first wall 201. The second front flange 242a comprises a fourth bore 244a which extends coaxially with the longitudinal axis 5. The second rear flange 242b comprises a fifth bore 244b which extends coaxially with the longitudinal axis 5.

The dimensions of these bores 244a, 244b are configured so that they can receive the first portion 502 of the sleeve 50. In this example, a radial assembly clearance is provided between the bores 244a, 244b and the first portion 502 of the sleeve 50 in order to allow deformation of the pads (described below) up to a predetermined load level.

The device 2 also comprises at least one pair of pads that allows predetermined deformation of the device 2 in order to at least partially absorb the load generated by the propulsion system 102. Implementing these pads makes it possible to obtain a “flexible mount”.

In this example, the device 2 comprises two pads, namely a front pad 262a and a rear pad 262b. The front pad 262a and rear pad 262b are arranged respectively bearing against the second front flange 242a and the second rear flange 242b.

The front pad 262a comprises a sixth bore 264a which extends coaxially with the longitudinal axis 5. The rear pad 262b comprises a seventh bore 264b which extends coaxially with the longitudinal axis 5.

The dimensions of these bores 264a, 264b are configured so that they can receive the first portion 502 of the sleeve 50. In this example, a radial assembly clearance is provided between the bores 264a, 264b and the first portion 502 of the sleeve 50 in order to allow deformation of the pads up to a predetermined load level. In this example, the pads 262a, 262b are made from an elastomer the elasticity of which can be selected as a function of the maximum deformation desired, for example.

More specifically, the first front flange 282a and rear flange 282b respectively bear against the front pad 262a and the rear pad 262b so that the front pad 262a is clamped between the second front flange 242a and the first front flange 282a, and so that the rear pad 262b is clamped between the second rear flange 242b and the first rear flange 282b.

Implementing the spacer 30 and the first flanges 282a, 282b therefore makes it possible, upon the tightening of the fastening screw 221, to clamp the elements of the device 2 together.

In this example, the first front flange 282a and rear flange 282b each comprise, on their faces that are facing each other when the device 2 is assembled, that is their faces in contact with a pad, cavities. More specifically, the first front flange 282a comprises a cavity able to receive the free end of the first portion 502 of the sleeve 50. In this example, an assembly clearance is provided between the cavity and the first portion 502 of the sleeve 50, in order to allow deformation of the pads 262a, 262b upon the tightening of the fastening screw 221.

The first rear flange 282b also comprises a cavity able to receive the shoulder 508 that separates the first portion 502 and second portion 504 of the sleeve 50.

In an embodiment variant illustrated in FIG. 3, rather than fastening the second front flange 242a and rear flange 242b to the first wall 201 of the support 20, the device 2 may employ a positioning assembly 25 configured to position the second front flange 242a and rear flange 242b axially with respect to the first wall 201. The second flanges 242a, 242b in this case are held against the first wall 201 by the tightening of the fastening screw 221, which action compresses the second flanges 242a and 242b against the first wall 201 of the support 20.

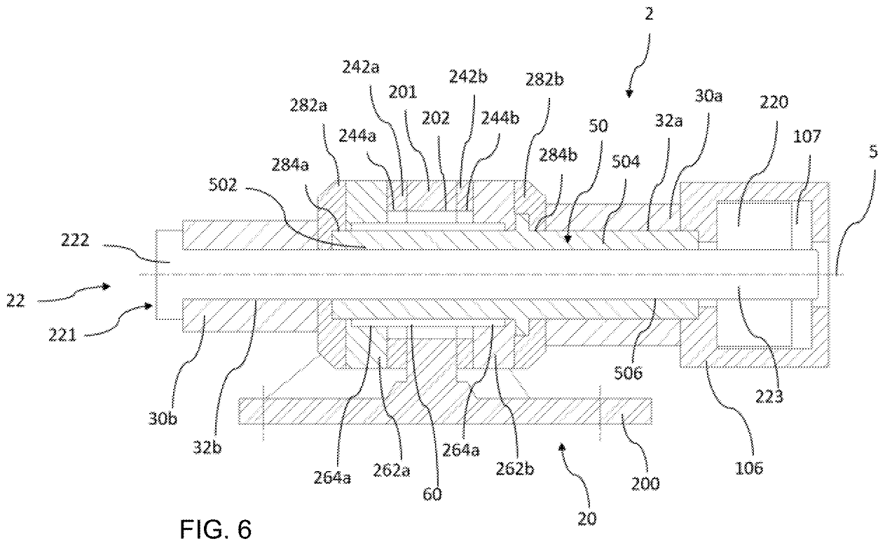

In this way, if the spacer 30 becomes crushed (as illustrated in FIG. 5), the support 20 can move parallel to the longitudinal axis 5. In this example, the support 20 moves towards the rear when the spacer 30 is crushed. Thus, the first front flange 282a, the front pad 262a and the second front flange 242a become detached from the rest of the device 2 (as illustrated in FIG. 5) so as to absorb the great load generated on the occasion of the failure and protect the structure of the aircraft 10.

In this particular example, the second front flange 242a comprises two first positioning slots 251a arranged at opposite ends of the second front flange 242a (in this instance at the opposite edges situated respectively to the starboard side and to the port side of the longitudinal axis 5). The second rear flange 242b similarly comprises two second positioning slots 251b arranged at opposite ends of the second rear flange 242b (in this instance at the opposite edges situated respectively to the starboard side and to the port side of the longitudinal axis 5). For its part, the first wall 201 comprises two positioning holes 211 arranged at opposite ends of the first wall 201 (in this instance at the opposite edges situated respectively to the starboard side and to the port side of the longitudinal axis 5).

The first positioning slots 251a, the second positioning slots 251b and the positioning holes 211 extend respectively coaxially with and generally parallel to the longitudinal axis 5. In other words, the positioning slots 251a, 251b and the positioning holes face one another.

In addition, the positioning assembly 25 in this example comprises two positioning pins 252 which each pass respectively through a first positioning slot 251a, through a second positioning slot 251b and through a positioning hole 211.

In this way, the second front flange 242a and rear flange 242b are positioned optimally with respect to the first wall 201 during normal operation of the device 2. In the event of failure, one of the second flanges 242a, 242b is able to move parallel to the longitudinal axis 5 so as to absorb the excessive load remaining after the spacer 30 has been crushed or broken and to further improve the protection afforded to the structure of the aircraft 10.

However, it will be understood that other positioning means 25, not described here, can be envisaged without departing from the principle of the invention.

Optionally, and as illustrated, the device 2 can implement a protective cylinder 60 that is fitted onto at least part of the first portion 502 of the sleeve 50. The cylinder 60 makes it possible to protect the sleeve 50 from any contact and friction between it and the support 20 upon the deformation of the pads 262a, 262b.

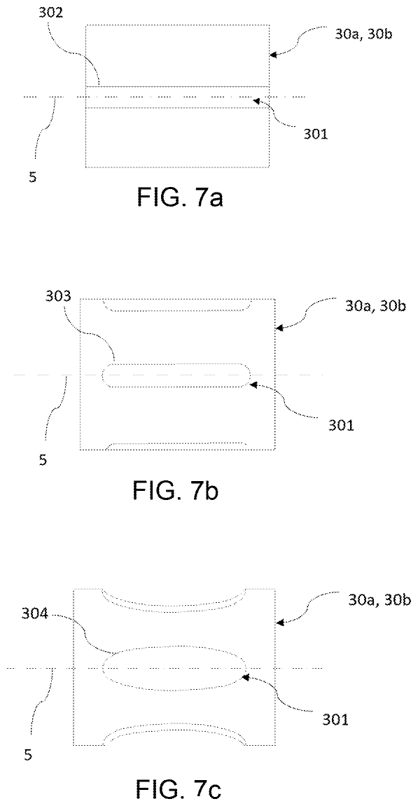

According to an embodiment variant, and as illustrated in FIG. 6, the device 2 according to the invention may comprise a second spacer 30b intended to be arranged between the first front flange 282a and the fastening head 222. In other words, the device 2 comprises a spacer 30a and a spacer 30b one on either side of the first wall 201. In this variant, the elements forming the device 2 are identical and are therefore not described again. In particular, the second spacer 30b may have an identical structure and characteristics to the first spacer 30a described above.

The second spacer 30b comprises a third central bore 32b which extends coaxially with the longitudinal axis 5 so that the second spacer 30b can be disposed onto the threaded shank 223 of the fastening screw 221. As illustrated, the fastening head 222 now bears against the second spacer 30b rather than against the first front flange 282a. Tightening the fastening screw 221 therefore allows the second spacer 30b to be compressed between the fastening head 222 and the first front flange 282a upon assembly of the device 2.

Implementation of this second spacer 30b therefore enables an even greater load to be absorbed in the event of failure. In addition, depending on the direction of the load applied to the device 2, this second spacer 30b also allows the support 20 to move towards the rear (not illustrated) in the event of failure. The protection afforded to the structure of the aircraft 10 is therefore further improved.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for coupling a propulsion system to an engine pylon of an aircraft, the device comprising:
a support substantially in a shape of an inverted T, the support comprising a base configured to be fastened to a propulsion system and a first wall extending substantially perpendicularly to the base, the first wall comprising a first bore extending along a longitudinal axis;
a substantially tubular sleeve comprising a first portion passing into the first bore and a second portion with a first end extending in a continuation of the first portion towards an engine pylon and a second end configured to interact with the engine pylon, the substantially tubular sleeve further comprising a first central bore coaxial with the longitudinal axis;
fastening means comprising a nut configured to be rigidly connected to the engine pylon and a fastening screw comprising a fastening head from which extends a threaded shank, the threaded shank passing through the first central bore and screwed into said nut;
a first front flange and a first rear flange, the first front flange and the first rear flange being arranged, respectively, on opposite sides of the first wall, the first front flange comprising a second bore extending coaxially with the longitudinal axis, the first rear flange comprising a third bore extending coaxially with the longitudinal axis; and,
a first spacer configured to be arranged between the first rear flange and the engine pylon, the first spacer comprising a second central bore coaxial with the longitudinal axis so that the first spacer is disposed on said second portion of the substantially tubular sleeve,
wherein the first portion of substantially tubular sleeve passes through the bores of the first front flange and the first rear flange,
wherein the fastening head bears against the first front flange,
wherein the first spacer comprises at least one weakened portion configured to allow the first spacer to deform when a force greater than a predetermined force is applied to the first spacer.

2. The device according to claim 1, further comprising:
a second spacer configured to be arranged between the first front flange and the fastening head, the second spacer comprising a third central bore coaxial with the longitudinal axis so that the second spacer is disposed on the threaded shank of said fastening screw and the fastening head bears against the second spacer,
wherein the second spacer further comprises at least one weakened portion configured to allow the second spacer to deform when a force greater than the predetermined force is applied to the second spacer.

3. The device according to claim 1, wherein the predetermined force is 2% greater than a maximum force applied to the first spacer in normal operation.

4. The device according to claim 1, wherein the weakened portion comprises a groove that extends generally parallel to the longitudinal axis.

5. The device according to claim 1, wherein the weakened portion comprises a groove that extends generally transversely with respect to the longitudinal axis.

6. The device according to claim 1, wherein the first spacer comprises a ductile material.

7. The device according to claim 1, further comprising:
a second front flange and a second rear flange, the second front flange and the second rear flange arranged, respectively, on opposite sides of the first wall, and in direct contact with the first wall, the second front flange comprising a fourth bore extending coaxially with the longitudinal axis, the second rear flange comprising a fifth bore extending coaxially with the longitudinal axis; and
a front pad and a rear pad arranged, respectively, against the second front flange and the second rear flange, the front pad comprising a sixth bore extending coaxially with the longitudinal axis, the rear pad comprising a seventh bore extending coaxially with the longitudinal axis,
wherein the first portion of the substantially tubular sleeve passes through the bores of the second front flange and the second rear flange and through the sixth bore and the seventh bore, and
wherein said device further comprises a positioning assembly for positioning the second front flange and the second rear flange with respect to the first wall.

8. The device according to claim 7, wherein the second front flange comprises two first positioning slots arranged at opposite ends of the second front flange,
wherein the said second rear flange comprises two second positioning slots arranged at opposite ends of the second rear flange,
wherein the first wall comprises two positioning holes arranged at opposite ends of the first wall,
wherein the two first positioning slots, the two second positioning slots, and the two positioning holes extend, respectively, coaxially with and generally parallel to the longitudinal axis, and
wherein the positioning assembly comprises two positioning pins which pass, respectively, through one of the two positioning slots, through one of the two second positioning slots, and through one of the two positioning holes.

9. An aircraft comprising:
a propulsion system;
an engine pylon; and
at least one device according to claim 1 coupling the propulsion system to the engine pylon,
wherein the support is fastened to the propulsion system, and
wherein the nut is rigidly connected to the engine pylon.
